(19) United States
(12) Patent Application Publication
(10) Pub. No.: US 2011/0278779 A1
(43) Pub. Date: Nov. 17, 2011

(54) TEST JIG STRUCTURE

(75) Inventors: Chao Wang Chang, Taipei (TW); Liang Jen Chang, Taipei (TW)

(73) Assignee: INVENTEC CORPORATION, Taipei (TW)

(21) Appl. No.: 13/009,691

(22) Filed: Jan. 19, 2011

(30) Foreign Application Priority Data
May 12, 2010 (TW) 099115192

(51) Int. Cl. B23Q 3/00

(52) U.S. Cl. 269/56

(57) ABSTRACT

A test jig structure is presented, which includes a frame, a substrate, and a carrying plate. The substrate is disposed in an accommodation space inside the frame. At least one slide rail is formed on the substrate. The slide rail includes a straight segment and a bending segment connected to the straight segment, and an angle exists between the straight segment and the bending segment. The carrying plate has at least one guiding member, and slides back and forth between the straight segment and the bending segment through the guiding member, so that the carrying plate can displace to a load position or a test position correspondingly.

### CROSS-REFERENCE TO RELATED APPLICATIONS

This non-provisional application claims priority under 35 U.S.C. §119(a) on Patent Application No(s). 099115192 filed in Taiwan, R.O.C. on May 12, 2010, the entire contents of which are hereby incorporated by reference.

### BACKGROUND OF THE INVENTION

1. Field of Invention

The present invention relates to a test jig structure, and more particularly to a test jig structure used for circuit board test having a substrate of which a slide rail having a bending segment is formed.

2. Related Art

With vigorous development of the electronics industry, various electronic products are widely used in daily life of modern people, such as computer main units, network servers, and industrial computers. Currently, in the development of this type of electronic products, when undergoing a final fabrication process of the product, the manufacturer inspects a circuit board of the product before it is assembled and delivered, so as to avoid errors that might occur later while being operated by users.

Conventionally, test work of the circuit board is performed on a production line, in which the circuit board is placed on a carrier which is driven into a tester in a manual operation mode. Subsequently, the circuit board is secured on a test position through the left, right, upper and lower bars of the tester respectively. The circuit board is then electrically connected to a test port to perform the test work.

However, such a manual operation mode is practically slow and labor consuming. Besides, it is unable to meet the high speed and low cost requirements when performing mass production. Therefore, subsequently a test jig is developed, in which a guide rail is disposed additionally on a substrate of a tester, so that the carrier can move forward or backward on the guide rail. However, although the test jig solves the problem of manual drive of the carrier, fabrication cost of the test jig is relatively increased. In addition, as the guide rail is disposed on the substrate of the tester, a size and occupation space of the test jig is also increased. Thus, not only the fabrication cost is increased but also a problem of space accommodation is caused at the same time.

Furthermore, although the test jig enables the carrier to move forward or backward on the guide rail, it is not practically used. That is to say, as a shape of the circuit board is a rectangle, a non-rectangle, or an irregular geometric shape, when a conventional guide rail having only a straight and level structure is used, the carrier can only displace and slide on the guide rail along a straight line. Under circumstances like these, the circuit board is unable to reach its test position (that is, a position of electrical connection with the test port) directly and effectively.

Next, in practical applications, in order to avoid some electronic components on the test jig or elements for use of test such as a connection port, an operator has to drive the circuit board to the test position through two-times straight-line displacement and actuation. That is to say, the operator has to manually drive the carrier to pass through two segments in both a forward direction and a traverse direction to reach the real test position for test work through said bars of the tester. Hereof, not only inconveniences during operations occur to the operator, but also the designs of the two-segment actuation structure and the whole mechanical connection thereof become more complicated.

### SUMMARY OF THE INVENTION

Accordingly, the present invention is a test jig structure, so as to not only solve problems of high fabrication cost of a conventional guide rail and large accommodation space of a jig, but also guide and position the carrier to a test position effectively.

The present invention provides a test jig structure, which comprises a frame, a substrate, and a carrying plate. An accommodation space is provided inside the frame. The substrate is disposed inside the accommodation space and at least one slide rail is formed on the substrate. The slide rail has a straight segment and a bending segment connected to the straight segment, and an angle exists between the straight segment and the bending segment. The carrying plate is moveably installed inside the accommodation space, and the carrying plate has at least one guiding member. The guiding member is arranged in the slide rail, and slides back and forth between the straight segment and the bending segment, thereby driving the carrying plate to displace to a load position or a test position correspondingly.

In the test jig structure provided in the present invention, the guiding member can further comprise a roller and the guiding member contacts the slide rail through the roller. When the guiding member slides back and forth in the slide rail, the roller rotates with the guiding member as an axle center.

In the test jig structure provided in the present invention, the substrate can comprise a plurality of slide rails, and each straight segment is kept in parallel with each other.

In the test jig structure in the present invention, the straight segment has two opposite ends. One end of the straight segment is connected to the bending segment and the other end of the straight segment is an inlet port, which is formed at a side edge of the substrate. The guiding member slides in the straight segment and the bending segment through the inlet port.

Therefore, in the test jig structure provided in the present invention, the slide rail is directly formed on the substrate, so as to decrease fabrication cost of additional guide rails and accommodation space of the test jig, and the slide rail has structure features of the straight segment and the bending segment, so that the carrying plate can be effectively positioned at the test position through the design of the bending segment.

### BRIEF DESCRIPTION OF THE DRAWINGS

The present invention will become more fully understood from the detailed description given herein below for illustration only, and thus are not limitative of the present invention, and wherein:

FIG. 1 is a 3D schematic view of a test jig structure according to a first embodiment of the present invention;

FIG. 2 is a schematic view of a position before loading according to FIG. 1;

FIG. 3 is a relative exploded view according to FIG. 1;

FIG. 4A is a schematic view of a load position according to FIG. 3;

FIG. 4B is a schematic view of a test position according to FIG. 3;

FIG. 5 is a structural view of a guiding member according to a second embodiment of the present invention; and

FIG. 6 is a structural view of a substrate according to a third embodiment of the present invention.

### DETAILED DESCRIPTION OF THE INVENTION

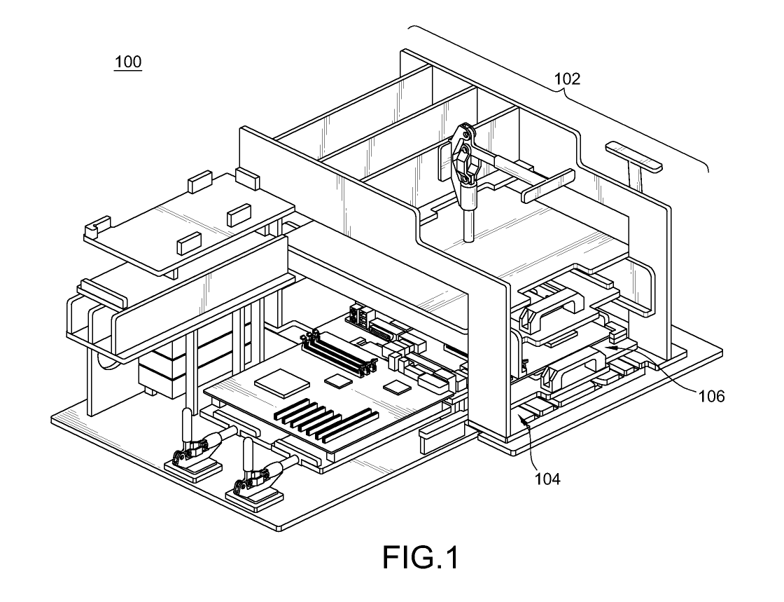

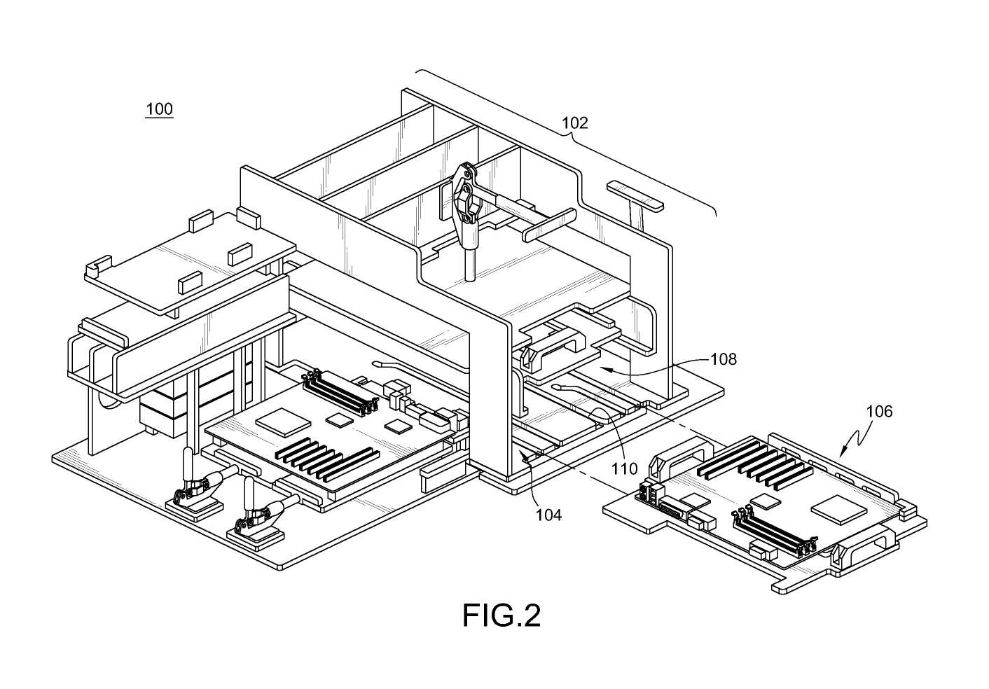

FIGS. 1 and 2 are 3D schematic views of a test jig structure 100 according to a first embodiment of the present invention. As shown in FIGS. 1 and 2, the test jig structure 100 in the first embodiment of the present invention comprises a frame 102, a substrate 104, and a carrying plate 106. An accommodation space 108 is provided inside the frame 102. The substrate 104 is disposed inside the accommodation space 108, and at least one slide rail 110 is formed on a side of the substrate 104. More precisely, the slide rail 110 is formed to be penetrating the substrate 104 as shown in FIG. 2. The carrying plate 106 is moveably installed inside the accommodation space 108. FIG. 1 is a schematic view that the carrying plate 106 is placed inside the accommodation space 108. FIG. 2 is a schematic view that the carrying plate 106 is placed outside the accommodation space 108.

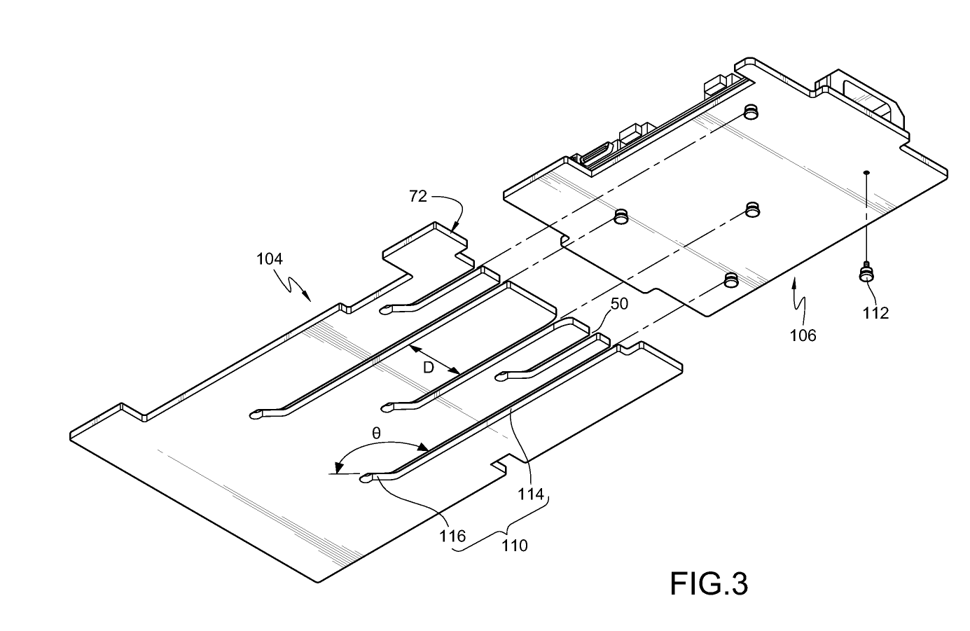

Referring to FIG. 3, the carrying plate 106 has at least one guiding member 112. The guiding member 112 can be located at a bottom of the carrying plate 106 to serve as an object for guiding the carrying plate 106 to slide. However, relative positions of the guiding member 112 and the carrying plate 106 are not limited thereto. The guiding member 112 can also be located at a position at a side edge of the carrying plate 106, as long as the carrying plate 106 can slide smoothly. The guiding member 112 is correspondingly arranged in the slide rail 110 and can slide back and forth in the slide rail 110.

For the test jig structure 100 according to the first embodiment of the present invention, in order to enable the carrying plate 106 to slide in the slide rail 110 stably through the guiding member 112, five slide rails 110 are formed on the substrate 104, and the carrying plate 106 has five guiding members 112. It should be noted here that for the test jig structure 100 according to the embodiment of the present invention, the numbers of the slide rails 110 and the guiding members 112 are not limited thereto, which can be designed depending on the demands in practical applications. In the first embodiment of the present invention, both the number of the slide rails 110 and the number of the guiding members 112 are set five as an example to facilitate the illustrative explanation below.

Next, as can be seen in FIG. 3, the substrate 104 comprises a plurality of slide rails 110. In order to enable the carrying plate 106 with the help of the guiding members 112 to slide in balance and not to overturn, the slide rails 110 can be kept in parallel with a distance D.

As shown in FIG. 3, the slide rail 110 has a straight segment 114 and a bending segment 116. The straight segment 114 of each slide rail 110 is kept in parallel with one another, and the bending segment 116 of each slide rail 110 is also kept in parallel with one another. The straight segment 114 and the bending segment 116 are connected to each other, and an angle θ exists between the straight segment 114 and the bending segment 116.

The straight segment 114 has two opposite ends. One end of the straight segment 114 is connected to the bending segment 116. The other end of the straight segment 114 is an inlet port 50, and the inlet port 50 is formed at a side edge 72 on the substrate 104 and is in communication with the outside. Here, the guiding member 112 can slide in the straight segment 114 and the bending segment 116 through the inlet port 50.

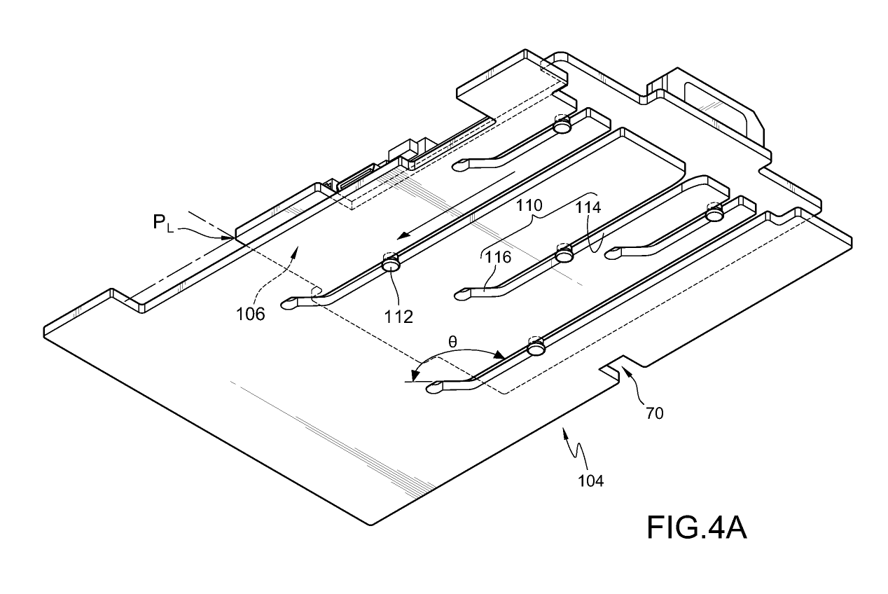

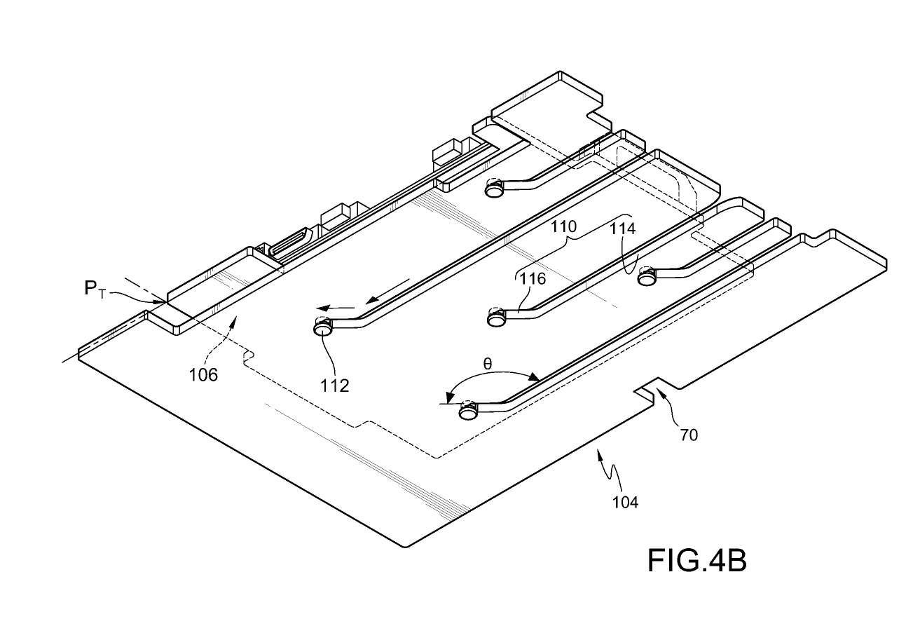

Referring to FIGS. 4A and 4B, the guiding members 112 are correspondingly arranged in the slide rails 110 and can slide back and forth between the straight segments 114 and the bending segments 116, so that the guiding members 112 can drive the carrying plate 106 to displace to a load position P_{L} or a test position P_{T} correspondingly.

As shown in FIG. 4A, when the guiding members 112 slide along the straight segments 114, the guiding members 112 slide in a horizontal traverse direction as shown by the arrow in FIG. 4A. Thus, the carrying plate 106 is located at the load position P_{L}. Next, as shown in FIG. 4B, when the guiding members 112 slide in the bending segments 116 passing through the angle θ, the guiding members 112 slide first in a horizontal traverse direction and then in a vertical direction as shown by the arrow in FIG. 4B, so that the carrying plate 106 is located at the test position P_{T}.

In the first embodiment according to the present invention, the substrate 104 further has an electrical connection port 70, and the electrical connection port 70 can be connected to a tester (not shown). Therefore, when the carrying plate 106 is located at the test position P_{T}, the tester can perform test work on a circuit board (not shown) through the electrical connection port 70 coupled to the circuit board on the carrying plate 106.

Therefore, in practical use, a designer can design a preferred length of the straight segment 114, a preferred length of the bending segment 116, and a preferred angle θ therebetween according to different circuit boards and carrying plates 106 (for example, according to different types, exterior structures, or shapes), so that when the guiding member 112 slides in the bending segment 116 passing through the angle θ, the carrying plate 106 can reach the test position P_{T} coupled to the electrical connection port 70 successfully, so as to facilitate subsequent test work of the circuit board. In conclusion, the test jig structure 100 can not only utilized to decrease the space of the jig and consumption of the fabrication cost, but also to achieve an effect of guiding and positioning the carrying plate 106.

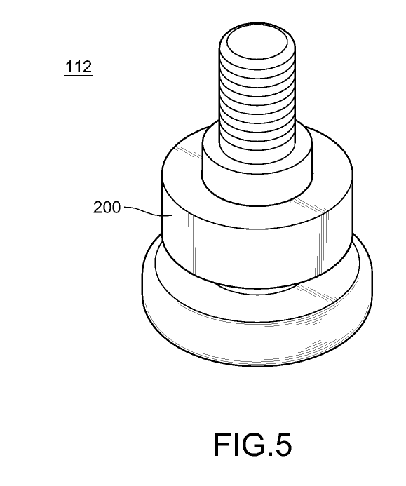

Next, in order to decrease a friction force when the guiding member 112 slides in the slide rail 110 and increase sliding efficiency of the guiding member 112, in a second embodiment according to the present invention, as shown in FIG. 5, the guiding member 112 can further has a roller 200, and the guiding member 112 can contact the slide rail 110 through the roller 200. Therefore, when the guiding member 112 slides back and forth in the slide rail 110, the roller 200 can rotate relatively with the guiding member 112 as an axle center, so as to reduce the friction force generated when the guiding member 112 slides in the slide rail 110.

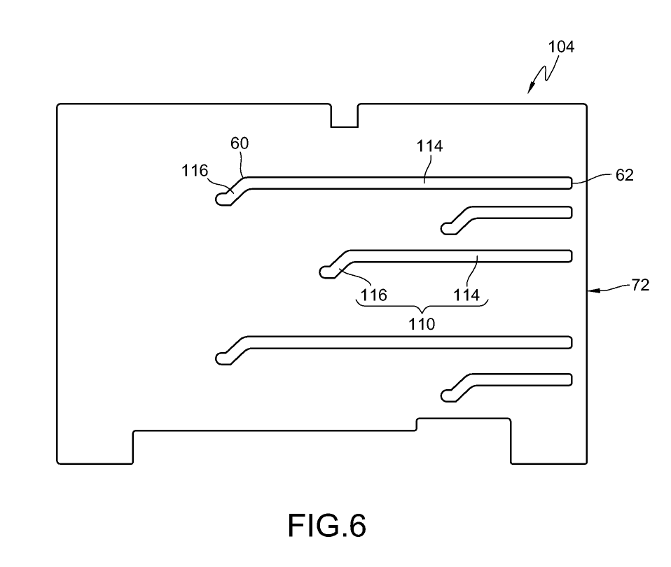

FIG. 6 shows a substrate 104 according to a third embodiment of the present invention. The straight segment 114 has a first connecting end 60 connected to the bending segment 116, and the straight segment 114 has a second connecting end 62 opposite to the first connecting end 60. As shown in FIG. 6, the second connecting end 62 is recessed in the substrate 104 and not in contact with the side edge 72 of the substrate 104. Thus, the second connecting end 62 is not in communication with outside as discussed above in the first embodiment, so that the guiding member 112 can be vertically placed in the slide rail 110 from above the substrate 104, so as to decrease fabrication cost of additionally forming an inlet position for the guiding member 112 on the substrate 104.

Therefore, for the test jig structure according to the embodiments of the present invention, additional fabrication cost of the test jig and the accommodation space of the test jig can be decreased through a structure in which the slide rail is directly formed on the substrate. Next, for the test jig structure according to the embodiments of the present invention, through the structure features that the slide rail has the straight segment and the bending segment and performing special design, the carrying plate can be positioned at the test position effectively through the angle θ between the straight segment and the bending segment.

What is claimed is:

1. A test jig structure, comprising:
a frame, wherein an accommodation space is provided inside the frame;
a substrate, disposed inside the accommodation space, wherein at least one slide rail is formed on the substrate, the slide rail has a straight segment and a bending segment connected to the straight segment, and an angle exists between the straight segment and the bending segment; and
a carrying plate, moveably installed inside the accommodation space, having at least one guiding member, wherein the guiding member is arranged in the slide rail, and slides back and forth between the straight segment and the bending segment, so as to drive the carrying plate to displace to a load position or a test position correspondingly.

2. The test jig structure according to claim 1, wherein the guiding member further comprises a roller, the guiding member contacts the slide rail through the roller, and when the guiding member slides back and forth in the slide rail, the roller rotates with the guiding member as an axle center.

3. The test jig structure according to claim 1, wherein the substrate comprises a plurality of the slide rails, and each straight segment is kept in parallel with each other.

4. The test jig structure according to claim 1, wherein the straight segment has two opposite ends, one end of the straight segment is connected to the bending segment, the other end of the straight segment is an inlet port formed at a side edge of the substrate, and the guiding member slides in the straight segment and the bending segment through the inlet port.
